(19) United States
(12) Patent Application Publication
(10) Pub. No.: US 2005/0200851 A1
(43) Pub. Date: Sep. 15, 2005

(54) Apparatus for measuring concentration of ice slurry

(76) Inventor: Naokatsu Kojima, Nagaizumi-cho (JP)

Correspondence Address: FLYNN THIEL BOUTELL & TANIS, P.C., 2026 RAMBLING ROAD, KALAMAZOO, MI, 49008-1631, US

(21) Appl. No.: 11/059,780

(22) Filed: Feb. 17, 2005

(30) Foreign Application Priority Data
Mar. 10, 2004 (JP) 2004-067309

(51) Int. Cl. G01N 21/00

(52) U.S. Cl. 356/436

(57) ABSTRACT

In an apparatus for measuring the concentration of ice slurry, a pair of through holes 2 is provided in diametrically opposite positions in a pipe wall 9 of an ice-slurry pipe 1 through which ice slurry 8 flows. Leading ends 4 of optical fibers 3 are fitted respectively in the through holes 2. The other end of each of the optical fibers 3 is connected to a light-quantity measurement unit 6. The light-quantity measurement unit 6 measures the concentration of the ice slurry 8 on the basis of information about the light quantity sent from the optical fibers 3.

### BACKGROUND OF THE INVENTION

1. Field of the Invention

This invention relates to a technique in the area of liquid honing using ice pellets as abrasives, more particularly, an apparatus capable of accurately measuring the concentration of ice slurry without the effect of the condensation phenomenon occurring on a pipe wall of a pipe through which ice slurry including ice pellets in suspension flows.

2. Description of the Related Art

The ice blasting process of directing ice slurry that includes a suspension of ice pellets in water toward the surface of an article undergoing the process do-es not cause any damage to the surface of the article. Further, the ice blasting process has an advantage in environmental protection terms because no abrasive is used so that a cleaning process is not required after the completion of the ice-blasting process and a disposal process for liquid wastes is simple. For these reasons, this kind of ice blasting process has recently captured much attention.

For the use of ice slurry in the ice blasting process, control of a ratio between ice pellets and water, namely the concentration, is very important. Conventionally, for the measurement of the ice-slurry concentration, the ice slurry is passed through a transparent pipe, and a set of light-quantity measurement sensors is provided on both sides of the transparent pipe. The amount of ice pellets flowing through the transparent pipe is sensed by the light-quantity measurement sensors.

However, the ice slurry has a low temperature of the order of zero° C. At room temperature, the pipe through which the ice slurry is flowing is cooled by the flowing ice slurry, and soon condensation occurs on the pipe wall to make the inside of the pipe invisible from the outside. If nothing is done, the light-quantity measurement sensors become inoperative. Hence, various measures against condensation are taken. For example, a portion of the transparent pipe on which the light-quantity measurement sensors are mounted is placed in a sealed container and the sealed container is filled with an inert gas such as N₂ gas or the like.

However, this structure presents the problems of the high cost required for achieving such a structure and of complicated maintenance checks, which thus is a factor in hindering the widespread use of the ice blasting process using ice slurry.

### BRIEF SUMMARY OF THE INVENTION

It is an object of the present invention to implement accurate measurement of concentration of ice slurry at low cost. To achieve this object, an apparatus for measuring concentration of ice slurry according to the present invention is designed such that a pair of through holes 2 is provided in diametrically opposite positions in a pipe wall 9 of an ice-slurry pipe 1 through which ice slurry 8 flows, and leading ends 4 of optical fibers 3 are fitted respectively in the through holes 2, while the other end of each of the optical fibers 3 is connected to a light-quantity measurement unit 6, and the light-quantity measurement unit 6 measures the concentration of the ice slurry 8 on the basis of information about the light quantity sent from the optical fibers 3.

### BRIEF DESCRIPTION OF THE DRAWINGS

FIG. 1 is a plan view of an embodiment of an ice-slurry concentration measuring apparatus according to the present invention.

### DETAILED DESCRIPTION OF THE INVENTION

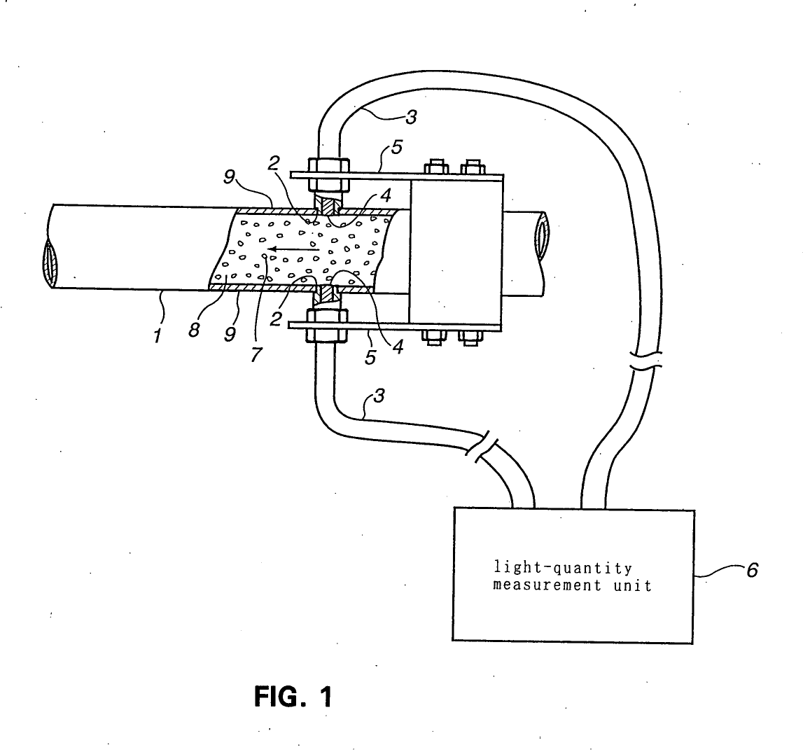

In FIG. 1, reference numeral 1 denotes an ice-slurry pipe through which ice slurry 8 passes. The ice-slurry pipe 1 is provided in an ice-slurry closed circuit of an ice blasting apparatus (not shown). The ice-slurry pipe 1 is not required to be transparent as in the case of a conventionally used pipe, but may be a typical metal pipe. A pair of through holes 2 is formed in diametrically opposite positions in a pipe wall 9 of the ice-slurry pipe 1. The leading ends of optical fibers 3 are fitted in the respective through holes 2.

In the embodiment, an internal-thread groove is formed in the inner periphery face of each through hole 2. An external-thread groove is formed in the outer periphery face of the leading end 4 of each optical fiber 3. The leading end 4 of the optical fiber 3 is screwed into the through hole 2 so as to be secured to the pipe wall 9 while the hermetically sealed state is maintained. Needless to say, another manner of securing rather than that described in the embodiment can be used. Reference numeral 5 in FIG. 1 denotes a fixing bracket for making the securing and holding of the optical fiber 3 reliable; this fixing bracket 5 clasps the vicinity of the leading end 4 of the optical fiber 3.

The other end of each of the pair of optical fibers 3 is connected to an optical-quantity measurement unit 6. The leading end 4 of one in the pair of optical fibers 3 operates as a light emitting portion and the leading end 4 of the other optical fiber 3 operates as a photodetector portion. The light-quantity measurement unit is designed to measure the concentration of the ice slurry 8 from the amount of ice pellets 7 flowing through the ice-slurry pipe 1 on the basis of light-quantity information sent from the optical fibers 3.

The present invention has the structure as described above, in which light is emitted from the leading end 4 of one of the optical fibers 3 fitted in the pipe wall 9 of the ice-slurry pipe 1 toward the inside of the pipe 1 through which the ice slurry 8 is flowing, and the leading end 4 of the other optical fiber 3 fitted in the diametrically opposite position of the pipe wall 9 detects the emitted light; the light-quantity unit 6 determines the amount of ice pellets 7 in the ice slurry 8 from the light emitting signal and the photodetector signal, and then measures the concentration of the ice slurry 8 on the basis of this determination. The measurement result is sent to an ice-slurry concentration adjusting apparatus (not shown) or the like to be used for the concentration control.

Effect of the Invention

Because the leading end 4 of each optical fiber 3 is positioned in the through hole 2 of the ice-slurry pipe 1, even if condensation occurs on the surface of the ice-slurry pipe 1, it is possible to sense the ice pellets 7 passing through the ice-slurry pipe 1 without any difficulty. Therefore, there is no need to place the ice-slurry pipe 1 in a sealed container filled with an inert gas as conventionally done. Thus, the ice-slurry concentration measuring apparatus of the present invention is capable of accurately measuring the concentration of the ice slurry 8 at low cost. Further, the present invention has advantages in cost and durability because the ice-slurry pipe 1 is not required to be transparent and may be a typical metal pipe.

1. An apparatus for measuring concentration of ice slurry, characterized in that:
a pair of through holes 2 are provided in diametrically opposite positions in a pipe wall 9 of an ice-slurry pipe 1 through which ice slurry 8 flows,
leading ends 4 of optical fibers 3 are fitted respectively in the through holes 2,
the other end of each of the optical fibers 3 is connected to a light-quantity measurement unit 6, and
the light-quantity measurement unit 6 measures the concentration of the ice slurry 8 on the basis of information about a light quantity sent from the optical fibers 3.
